(19) United States
(12) Patent Application Publication
(10) Pub. No.: US 2019/0132323 A1
(43) Pub. Date: May 2, 2019

(54) SYSTEMS AND METHODS FOR DYNAMICALLY ADJUSTING A PASSWORD ATTEMPT THRESHOLD

(71) Applicant: MasterCard International Incorporated, Purchase, NY (US)

(72) Inventors: Kyle Williams, Wentzville, MO (US); David J. Senci, Troy, IL (US)

(21) Appl. No.: 15/796,553

(22) Filed: Oct. 27, 2017

(51) Int. Cl. H04L 29/06; H04L 9/32

(52) U.S. Cl. CPC H04L 63/102; H04L 63/083; H04L 9/3226

(57) ABSTRACT

A system for dynamically adjusting a default password attempt threshold is provided. The system includes a server for storing the digital account, and a dynamic password computing device for controlling access to the server. The dynamic password computing device is configured to receive an access request from a user using a first user device for accessing the digital account wherein the access request includes first user device data elements and an account ID, retrieve a historical account profile of the user that includes user device data elements for one or more user devices used by the user to access the digital account, compare the first user device elements from the access request to the historical account profile of the user, determine a likelihood that the user submitting the access request is a legitimate account holder, and adjust the default password attempt threshold stored within the memory based on the determination.

### BACKGROUND

The field of the disclosure relates generally to securing electronic information through a password security system, and more particularly, to systems and methods for determining security risk and dynamically adjusting a number of password attempts allowed before a user account is locked or otherwise secured.

Data providers have popularized the use of digital account systems that are accessible by data users by providing account security to help prevent information and/or data theft. Many data users use digital account systems to conveniently access data provided by data providers without having to be physically present at the provider's location. These digital account systems are used for a wide variety of purposes, such as but not limited to, buying goods and/or services from a vendor, editing personal and payment information, making payment card payments, and/or transferring money between bank accounts. Many providers utilize a variety of methods to increase the security of each digital account, such as password lockout functionality. With password lockout functionality, a user is allowed a defined number of attempts to enter a password before locking the digital account. For example, in a situation where a non-owner of a digital account attempts to login to the digital account, and enters an incorrect password a number of times that is equal to or greater than a threshold attempt amount, the digital account is locked until an account manager is contacted and further steps are taken to unlock the account.

Unfortunately, there are many instances when a legitimate user of the digital account is accidentally locked out of the digital account. This happens for a variety of reasons, such as but not limited to, forgetting the password or mistyping the password. For example, some digital account owners do not need to routinely access the digital account, and a long period of time passes between account logins. In this situation, a user is more likely to forget the account password. As an additional security measure, many systems require a user to frequently change their password. This situation can lead to confusion as to which password is the current password, often resulting in multiple login attempts. These multiple login attempts can violate the threshold attempt number, and thus, result in a locked account for the legitimate user. This can cause a great deal of frustration on the part of the user. Accordingly, a system is needed that will dynamically adjust the threshold attempt number based on a variety of device and user data to avoid these unnecessary lockouts.

### BRIEF DESCRIPTION

In one aspect, a system for dynamically adjusting a default password attempt threshold used for accessing a digital account is provided. The system includes a server for storing data for multiple digital accounts including the digital account, and a dynamic password computing device for controlling access to the server and the digital account stored thereon. The dynamic password computing device includes at least one processor and a memory. The at least one processor is configured to store the default password attempt threshold in the memory, receive an access request from a user using a first user device for accessing the digital account wherein the access request includes a plurality of first user device data elements and an account ID, retrieve a historical account profile of the user based on the account ID wherein the historical account profile includes user device data elements for one or more user devices used by the user to access the digital account, compare the first user device elements from the access request to the historical account profile of the user, determine a likelihood that the user submitting the access request is a legitimate account holder based on the comparison, and adjust the default password attempt threshold stored within the memory based on the determination.

In another aspect, a dynamic password computing device for controlling access to a digital account stored on a server is provided. The dynamic password computing device includes at least one processor and a memory. The at least one processor is configured to store a default password attempt threshold in the memory, receive an access request from a user using a first user device for accessing the digital account wherein the access request includes a plurality of first user device data elements and an account ID, retrieve from the memory a historical account profile of the user based on the account ID wherein the historical account profile includes user device data elements for one or more of the user devices used by the user to access the digital account, compare the first user device elements to the historical account profile of the user, determine a likelihood that the user submitting the access request is a legitimate account holder based on the comparison, and adjust the default password attempt threshold based on the determination.

In yet another aspect, a computer-implemented method for dynamically adjusting a default password attempt threshold used for accessing a digital account is provided. The method is implemented using a dynamic password computing device. The method includes storing by the dynamic password computing device a default password attempt threshold in a memory, receiving an access request from a user using a first user device for accessing the digital account wherein the access request includes a plurality of first user device data elements and an account ID, retrieving a historical account profile of the user based on the account ID wherein the historical account profile includes user device elements for one or more user devices used by the user to access the digital account, comparing the first user device elements from the access request to the historical account profile of the user, determining a likelihood that the user submitting the access request is a legitimate account holder based on the comparison, and adjusting the default password attempt threshold based on the determination.

In yet another aspect, a computer-readable storage media for dynamically adjusting a default password attempt threshold used for accessing a digital account is provided. The computer-readable storage media having computer-executable instructions embodied thereon, wherein, when executed by at least one processor of a dynamic password computing device, the computer-executable instructions cause the processor to store a default password attempt threshold in a memory, receive an access request from a user using a first user device for accessing the digital account wherein the access request includes a plurality of first user device data elements and an account ID, retrieve a historical account profile of the user based on the account ID wherein the historical account profile includes user device elements for one or more user devices used by the user to access the digital account, compare the first user device elements from the access request to the historical account profile of the user, determine a likelihood that the user submitting the access request is a legitimate account holder based on the comparison, and adjust the default password attempt threshold based on the determination.

### BRIEF DESCRIPTION OF THE DRAWINGS

FIG. 1 is a diagram of an example embodiment of a system configured to dynamically adjust the number of password attempts allowed for a digital account.

FIG. 2 is a box diagram of an account access computing device used in the system shown in FIG. 1.

FIG. 3 illustrates an example configuration of a first user device used in the system shown in FIG. 1.

FIG. 4 illustrates an example configuration of a server used in the system shown in FIG. 1.

FIG. 5 is a diagram of components of one or more example account access computing devices used in the system shown in FIG. 1.

FIG. 6 shows a method for dynamically adjusting the number of password attempts allowed for a digital account using the account access computing device shown in FIG. 1.

### DETAILED DESCRIPTION

The disclosure describes a dynamic password system and method having a dynamic password computing device that is configured to dynamically adjust a number of password attempts allowed for a digital account (also known as “threshold attempt number”, or “threshold attempt rule”), such as, but not limited to, an online bank account. The dynamic password system shall be described herein as “the system”. The system decreases instances of false account lockouts and increases digital account security, wherein false account lockouts occur when a legitimate or authorized user of an account exceeds the number of password attempts, and is subsequently “locked-out” of the digital account. When a digital account is locked-out, the user can no longer make password attempts to login to the digital account at least for some period of time, and typically must contact a digital account manager to unlock the account so that the legitimate user is able to access the digital account. A password attempt occurs when a user, using a first user device, enters a password or passcode into a web site or application software in order to access a digital account or some other secure data.

A digital account, such as an online account, may include any data stored on a database that is associated with or owned by a user. The digital account may be managed by an account manager associated with a data provider, wherein the data provider is at least one of, but not limited to, a merchant, a card issuer, a bank, and/or a third party entity.

The system described herein includes a server for storing data for multiple digital accounts including the digital account. In the example embodiment, the server is associated with a merchant store or a bank, and stores user account data, and sends, receives, and processes signals from various sources.

The system further includes a dynamic password computing device configured to control access to the server and the digital accounts stored thereon. The dynamic password computing device includes at least one processor and a memory. The processor is configured to receive device data from a user device. In one embodiment, the server and the account access computing device are configured to communicate with one another. In an alternative embodiment, the server includes the account access computing device.

The dynamic password computing device is configured to collect, store, and analyze user device data and/or other user data to determine a level of security risk associated with an attempted login of a digital account. The user device is any device suitable to access a digital account. For example, the user device includes, but is not limited to, a mobile device, a cell phone, a tablet, a laptop, a wearable computing device, and/or any other computing device. User device data includes all data associated with a specific user device, including but not limited to, a device ID, IP address, MAC address, browser type, and any other such device data that may be stored between devices when a user device accesses a website. User data includes, but is not limited to, the user's name, the user's address, and/or the user's biometric data. User data is initially captured after the user enters the user data when registering for a user account. The system uses the user device data captured from previous logins made into the digital account and compares it to the device data of the current login (also referred to as the candidate login). The previous data stored in the system is described herein as user profile data.

The system further is configured to analyze the collected data (user device data and user data) from each previous login and/or login attempt, and recognize login patterns related to the user device and the digital account. If the collected data from a login attempt does not match the user profile data, and/or the current login data does not fall within a common login pattern associated with the historic data, a security risk is identified by the dynamic password computing device, and the default password attempt threshold of the digital account is adjusted. The default password attempt threshold, or threshold, is the number of incorrect password attempts accepted by the dynamic password computing device before a digital account is locked or otherwise secured. When a security risk is identified, the threshold may be kept the same or lowered. Similarly, when the current device data and the historic data match, and/or the current data falls within a common login pattern or trend associated with the historic data, the threshold may be raised, and thus, a higher number of password attempts could be submitted before the account would be locked or otherwise secured.

The processor is further configured to store the default password attempt thresholds of one or more digital accounts in the memory. In an embodiment, when a determination is made, the processor adjusts the threshold. In this embodiment, the processor stores and continuously updates the threshold number for each specific digital account. In the example embodiment, after the password attempt threshold is adjusted for the current login attempt, the password attempt threshold is then reset to the default password attempt threshold.

The processor is further configured to receive an access request from a user using a first user device. The access request is a digital message, sent wirelessly or over a wire, that includes a plurality of user device data, or user device data elements, user data, and an account ID associated with the relevant digital account. A user makes an access request when they attempt to login to the digital account by entering a password into a data field by using the user device. The processor is configured to receive multiple access requests at once. For example, when a user wishes to access the digital account, the user either opens up the home page or login page of either a website or a mobile application associated with the digital account, and further inputs a password. The inputting of the password initiates an access request.

The processor is further configured to retrieve, from the memory, a historical account profile of the user. The historical account profile is a plurality of data elements associated with a specific user and user device associated with the respective digital account. The historical account profile includes both user device data and user data. The historical account profile may also include device data from multiple user devices associated with a single user.

In one embodiment, the dynamic password computing device receives an access request containing device data and user data by way of a web data extraction script. The web extraction script is programmed to communicate with at least one of the processor and/or memory. For example, the web data extraction script is programmed to initiate a user access request when a user enters a password into an application or website.

The processor is further configured to compare the user device and user data elements to the historical account profile of the user. For example, the historic data, associated with the historic profile, is used to identify the legitimate user of the respective digital account, and to identify login patterns specific to the user of the digital account. The login patterns specific to the user account include, but are not limited to, the common time or timeframe that the user typically logs into the digital account, the average amount of time between sequential password attempts, the average amount of password attempts before successful login, the number of correct password attempts, the number of incorrect password attempts, the percentage of correct and/or incorrect password attempts, and the common location or locations where the user initiates a password attempt.

The common timeframe includes at least one of a time, a range of times, a date, and/or a range of dates associated with a specific user account profile. In one embodiment, the common timeframe is calculated using all the dates and time associated with previous logins. Here, the common timeframe is the dates and times in which a specific user most frequently makes a password attempt.

In one embodiment, the average amount of time between sequential password attempts includes the time between the present password attempt and the previous password attempt. This number may be used in determining whether the threshold is raised or lowered. For example, a longer average amount of time between sequential password attempts may indicate that a user does not frequently attempt to login to the respective digital account. If the time between the current password attempt and the previous password attempt is significantly lower than the average, the threshold may be raised.

In one embodiment, the common location or locations where the user initiates a login attempt may include the most frequent city, state, and/or country in which previous password attempts were made.

Initial device data and user data are captured and stored within the memory when a user first registers for a digital account. Subsequent login/password attempts add additional data elements in association with the specific user account, providing a more extensive data set for the identification of login patterns.

The processor is further configured to determine a likelihood that the user submitting the access request is a legitimate account holder. A legitimate account holder is herein defined as the true owner of the digital account. A determination is made by comparing the user device data from the current password attempt with the historic data profile as described above.

A security score associated with the determination is generated as a means to indicate the security risk identified in the determination. The security score is an indication of the presence of a security risk that is calculated by comparing user device data elements of the current login attempt and the historical account profile, and applying the comparison to a set of predetermined rules stored within said memory. In some embodiments, the predetermined rules include any number of factor weights used to generate the security score based on comparing the user device data elements of the current login attempt to the historic account profile. In one embodiment, for example, the predetermined rules may include a weight of 0.5 for a matching comparison of a device ID between the current login attempt and the historic account profile. In another embodiment, the predetermine rules may include a weight of 0.3 for a matching comparison of a location-associated IP address to a zip code included in the historic account profile, where the location-associated IP address is included in the current login attempt. In the example embodiment, the memory is configured to store a plurality of rules that, when analyzed together with the historic account profile and the current login request, are used to calculate the security score.

For example, one rule may include the raising of the security score in a situation where the device ID of the user device used in the current login attempt does not match any of the device ID's stored included within the historical account profile associated with the digital account. In this embodiment, the heightening of the security score indicates a higher risk of a security threat associated with the current login attempt. Each rule of the plurality of rules influences the security score, such that no individual rule is determinative of the security score.

In one embodiment, the security score is a number that is indicative of how high or low the security risk is for the current login attempt of the digital account. A high security score indicates a lower security risk and a low security score indicates a higher security risk. For example, in one embodiment, the default security score may be 500. In this embodiment, the security score may be heighted by the processor for every consistency detected, and may be lowered for every inconsistency detected. In another embodiment, the default security score may be 5000. In this embodiment, the security score may be lowered by the evaluator for every consistency detected, and may be heightened by the evaluator for every inconsistency detected. In yet another embodiment, the security is measured by a series of letters. For example, the security score is measured by the series “A” through “F”, where the letter “A” indicates the highest level of security, and the letter “F” indicates the lowest level of security, or the highest risk of fraudulent activity.

Moreover, the processor matches the current data with the login patterns associated with the historic data. For example, a rule may dictate that if a time associated with the current login attempt does not fall within the common timeframe included within the historic account profile, the security score may be lowered. It should be noted that, in different embodiments, a higher security score may indicate a higher security risk, and a lower security score may indicate a lower security risk. Moreover, the security score is used in a way that indicates a level of security risk, and is not limited to any particular series of numbers or letters.

After the determination is made, the processor is further configured to adjust and save in memory the default password attempt threshold based on the determination.

In one embodiment, after a security score is created, the dynamic password computing device communicates the security score to the server, because in this embodiment, the server would maintain the password attempt threshold for the digital accounts. In one embodiment, the communication is in the form of a digital flag that is a translation of the security code as described above. In this embodiment, the server analyzes the code and either increases or decreases the password attempt threshold. For example, if a determination is made that there exists a low level of security risk, and a security score reflecting the determination is created, a digital flag is sent to the server communicating the determination. The server then either heightens or lowers the password attempt threshold. By decreasing the threshold in a situation with high risk for a fraudulent login, the security of the digital account is increased. In another embodiment, the dynamic password computing device creates the security code and adjusts the threshold for the digital account.

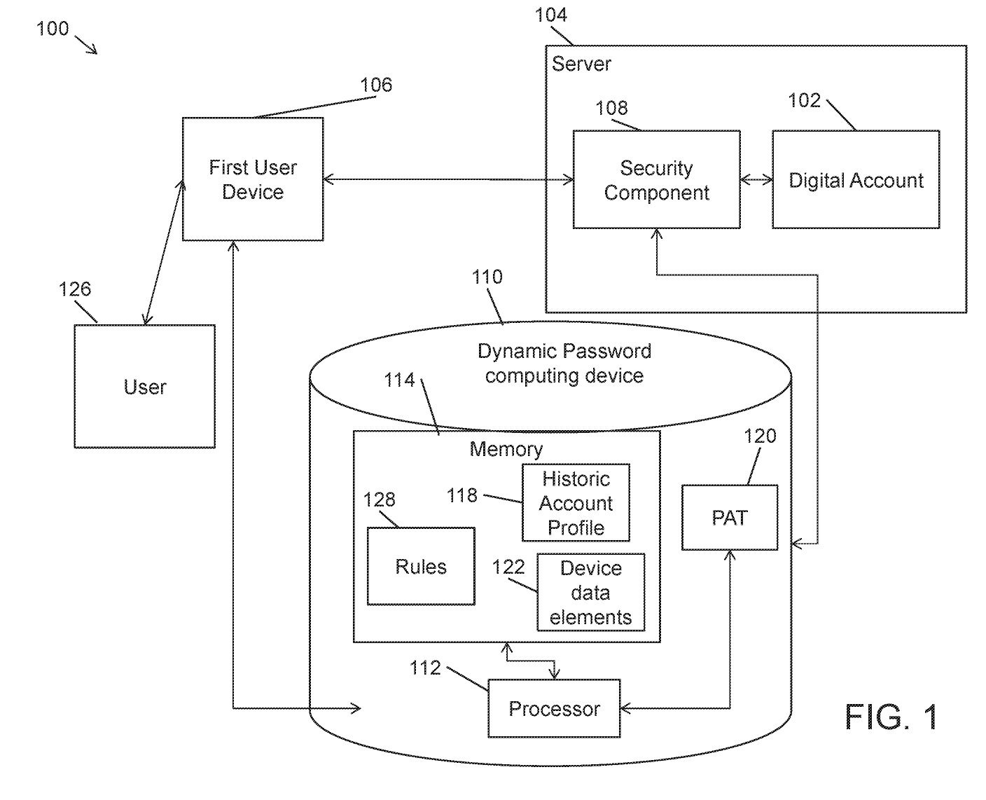

FIG. 1 shows a diagram of an example embodiment of a dynamic password system 100 configured to dynamically adjust the number of password attempts allowed for a digital account 102. System 100 includes a dynamic password computing device 110, wherein dynamic password computing device 110 includes a processor 112 associated with a memory 114. Memory 114 is configured to store a plurality of historic account profiles 118, wherein each historic account profile 118 includes a plurality of device data elements 122 form a plurality of previous logins and user data elements. Memory 114 is further configured to store a password attempt threshold (PAT) 120. Processor 112 is configured to dynamically adjust the password attempt threshold 120 after a likelihood of security risk determination is made.

In the example embodiment, dynamic password computing device 110 is configured to communicate with at least one of a server 104 and/or a user device 106. Server 104 includes a security component 108 and digital account 102. Security component 108 may be any security system, method, or device used to protect the sensitive information associated with a digital account 102, including but not limited to, user device data elements and user data.

As described above, user device 106 is any device suitable for accessing digital account 102, such as, but not limited to, a mobile device, a cell phone, a tablet, a laptop, and/or a computer. Digital account 102 is any account used for a service suitable to store information digitally, such as, but not limited to, a digital bank account, and/or a merchant store account. Server 104 is any database and/or server configured to communicate with user device 106. Server 104 is further configured to process and/or store user device data and/or user data associated with digital account 102.

In the example embodiment, threshold 120 is a defined number that is stored within server 104 and memory 114. For example, the threshold 120 may be set at three attempts. If a user 126 enters an incorrect password into the user device 106 a number of times equal or greater than threshold 120, digital account 102 is locked. User 126 can no longer make a password attempt until digital account 102 is unlocked.

As shown in FIG. 1, user 126 first accesses the home page and/or login page of the website and/or application, associated with digital account 102, by accessing user device 106. User initiates an access request by inputting a password attempt into user device 106. The access request includes a plurality of user device data elements 122 and user data associated with digital account 102. In one embodiment, when user device 106 opens the home page/login page, a data collection script begins to run, wherein the data collection script initiates the access request.

The access request is received by dynamic password computing device 110. Moreover, the device data 122 is sent to processor 112, and is further stored in memory 114. The access request triggers processor 112 to compare device data elements 122 with data from historical account profile 118. After the comparison is made, a determination of a security risk is made, and processor 112 generates a security score.

As described above, the security score is an indication of the presence of a security risk that is calculated by comparing user device data elements 122 of the current login attempt and data from historical account profile 118, and further applying the comparison to a plurality of predetermined rules 128 stored within said memory. In some embodiments, predetermined rules 128 include any number of factor weights used to generate the security score based on comparing the user device data elements of the current login attempt to historic account profile 118. In one embodiment, for example, predetermined rules 128 may include a weight of 0.5 for the comparison of a device ID between the current login attempt and the historic account profile 118. In another embodiment, predetermine rules 128 may include a weight of 0.3 for the comparison of a location-associated IP address to a zip code included in historic account profile 118, where the location-associated IP address is included in the current login attempt. In the example embodiment, memory 114 is configured to store a plurality of rules 128 that, when analyzed together, are used to calculate the security score.

In one embodiment, the security score is a default score, and is heightened or lowered based upon a determination after comparing the current device data 122 and the historic account profile 118. In the example embodiment, the default score is a defined number or letter. In another embodiment, the default security score is defined by the digital account manager. The determination is made by accessing the level of security risk associated with the current password attempt.

After a determination is made, and processor 112 generates a security score, processor 112 communicates the security score with server 104. In one embodiment, processor 112 sends the security score through a wireless signal to security component 108. Security component 108 uses the security score to adjust threshold 120 relative to the default number of password attempts allowed. In the example embodiment, the security score indicates either a high level of risk, a neutral level of risk, or a low level of risk associated with the current login attempt. If the security score is raised higher than the default security score, the level of risk is assumed to be high, and the threshold may be kept the same or lowered. If the security score is lowered past the default security score, the level of risk is assumed to be low, and the threshold is kept the same or heightened.

In another embodiment, the security score may be based on a tiered system, where each tier represents a different level of risk associated with the present login attempt. Each tier may cause a different number adjustment for the number of allowed password attempts. For example, the security score may have a default tier of 5, which represents a neutral risk, and wherein the number of password attempts is not adjusted. If a high number of inconsistencies are found, then the default tier may be raised anywhere between the number 6 and the number 10, where the number 6 represents a low security risk, and 10 represents a high security risk. Fewer password attempts may be granted if the level of risk is higher.

After the a determination is made and the threshold is either kept the same or adjusted, user 126 may be notified of any adjustments or non-adjustments, for example, through text message or notification.

In another embodiment, dynamic password computing device 110 is configured to send a security code to user 126 if a high level of security risk is determined. In this embodiment, processor 112 generates a security score by comparing current device data with historic profile 118 in the same way as described above. If the security score indicates a high security risk, dynamic password computing device 110 signals security component 108, and security component 108 sends a passcode directly to user 126 and/or user device 106. In order for user 126 to be allowed a password attempt, user 126 must enter the identical passcode into a prompt on the login page associated with digital account 102. The passcode is sent to user 126 by way of, but not limited to, text message and/or email. In an embodiment, if user 126 enters an incorrect passcode, digital account 102 is locked.

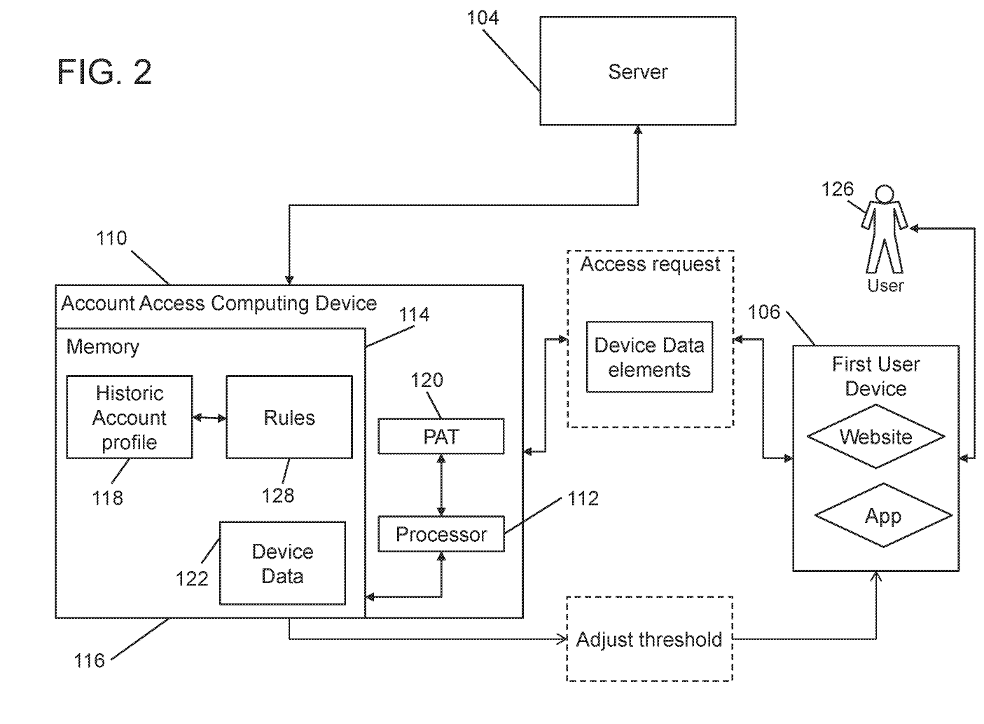

FIG. 2 shows a box diagram of account access computing device 110 used in system 100 shown in FIG. 1. As described above, dynamic password computing device 110 includes processor 112 associated with memory 114, configured to work together to dynamically adjust threshold 120 after a determination of the level of security risk associated with a current password/login attempt.

In the example embodiment, user device 106 is a mobile device, such as any mobile device capable of interconnecting to the Internet including a web-based phone, also referred to as smart phone, personal digital assistant (PDA), a tablet, or other web-based connectable equipment. In an alternative embodiment, user device 106 is a desktop computer or a laptop computer. User device 106 may be associated with a user 126. User device 106 may be interconnected to the Internet through a variety of interfaces including a network, such as a local area network (LAN) or a wide area network (WAN), dial-in connections, cable modems and special high-speed ISDN lines. In some embodiments, user device 106 includes a software application (i.e., a service app) installed on user device 106. In additional embodiments, user device 106 displays a customized website using a web browser installed on user device 106. In further embodiments, user device 106 is in communication with a geopositioning network to facilitate GPS functionality of user device 106.

As described above, memory 114 is configured to store historic account profile 118, device data/elements 122, and rules 128. The plurality of historic device data included within historic account profile 118 includes, but is not limited to, an IP address identifying a specific computer, a MAC address, a web browser, a device ID identifying a specific user device 106, and identified login patterns associated with a specific user 126 as described above.

In the example embodiment, the login success rate is defined as the number of successful password attempts divided by the overall number of password attempts. User data includes user's 126 data associated with digital account 102. For example, user data may include, but is not limited to, the user's name, the user's current password, the user's address, the user's phone number, and/or the user's bank account number. Login patterns may include, but are not limited to, the common time or timeframe that the user typically logs into the digital account, the average amount of time between sequential password attempts, the average amount of password attempts before successful login, the number of correct password attempts, the number of incorrect password attempts, the percentage of correct and/or incorrect password attempts, and the common location or locations where the user initiates a password attempt. Processor 112 generates the security score based on whether or not the current device data 122 fall within the identified login pattern or login patterns.

In the example embodiment, dynamic password computing device 110 is configured to send and receive current device data 122 to and from user device 106 and digital account 102. Although only user 126, one user device 106, and one digital account 102 are illustrated, it should be understood that the system 100 may include any number of users 126, user devices 106, and/or digital accounts 102 in communication with dynamic password computing device 110.

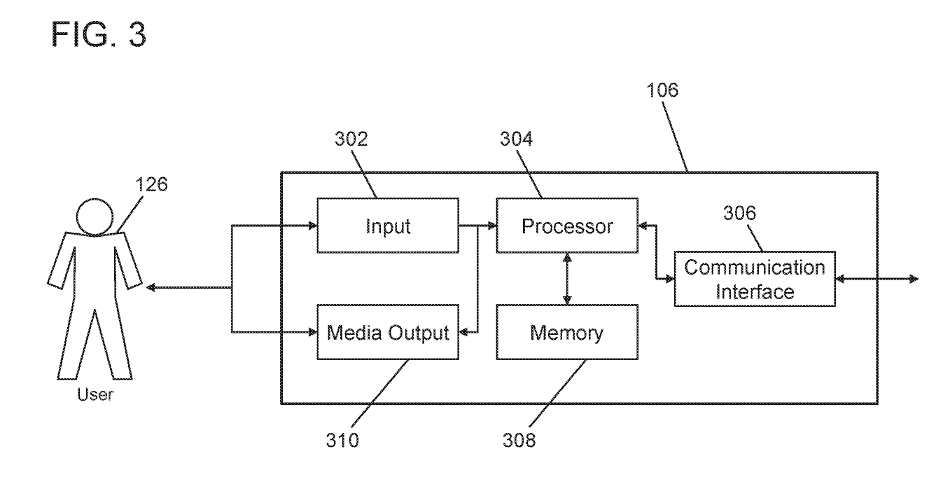

FIG. 3 illustrates an example configuration of a user device as shown in FIG. 1. User device 106 may include, but is not limited to, a smart phone, a tablet, and a website. In the example embodiment, user device 106 includes a processor 304 for executing instructions. In some embodiments, executable instructions are stored in a memory area 308. Processor 304 may include one or more processing units, for example, a multi-core configuration. Memory area 308 is any device allowing information such as executable instructions and/or written works to be stored and retrieved. Memory area 308 may include one or more computer readable media.

User device 106 also includes at least one media output component 310 for presenting information to user 126. Media output component 310 is any component capable of conveying information to user 126. In some embodiments, media output component 310 includes an output adapter such as a video adapter and/or an audio adapter. An output adapter is operatively coupled to processor 304 and operatively couplable to an output device such as a display device, a liquid crystal display (LCD), organic light emitting diode (OLED) display, or “electronic ink” display, or an audio output device, a speaker or headphones.

In some embodiments, user device 106 includes an input device 302 for receiving input from user 126. Input device 302 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 310 and input device 302. User device 106 may also include a communication interface 306, which is communicatively couplable to a remote device such as the digital account. Communication interface 306 may include, for example, a wired or wireless network adapter or a wireless data transceiver for use with a mobile phone network, Global System for Mobile communications (GSM), 3G, or other mobile data network or Worldwide Interoperability for Microwave Access (WIMAX), or an 802.11 wireless network (WLAN).

Stored in memory area 308 are, for example, computer readable instructions for providing a user interface to user 126 via media output component 310 and, optionally, receiving and processing input from input device 302. A user interface may include, among other possibilities, a web browser and client application. Web browsers enable users, such as user 126, to display and interact with media and other information typically embedded on a web page or a website. A client application allows user 126 to interact with a server application from a server system.

In some embodiments, user device 106 includes a global positioning system (GPS) sensor integral with communication interface 306, input device 302, or as a separate component. The GPS sensor is configured to receive signals from a plurality of GPS satellites and to determine the location of the GPS sensor and the mobile device using the signals. More specifically, the GPS sensor determines geolocation information for user device 106. The geolocation information may be calculated, for example, by communicating with satellites using communication interface 306. The GPS sensor determines the location of the mobile device and, therefore, the location of mobile device user (i.e., user 126). For example, the GPS sensor functions as a GPS receiver and receives signals from at least three GPS satellites. The received signals include a time stamp at which the signal was sent and a satellite identifier. The GPS sensor is configured to “reverse engineer” the locations of the GPS satellites and, from the satellites' positions, determine its own location based on how long it took (from the time each signal was sent) to receive each signal. In some cases, the GPS sensor is configured to analyze other data streams to supplement this location-determination process. For example, the GPS sensor may access cellular tower data (e.g., by “pinging” a nearby cell tower) to determine its approximate location and, from that information, only analyze signals from the three nearest GPS satellites. User device 106 may additionally or alternatively include other components such as an accelerometer, gyroscope, and/or any other position and/or location-determining components. User device 106 may be used to download a digital account software application in connection with digital account 102.

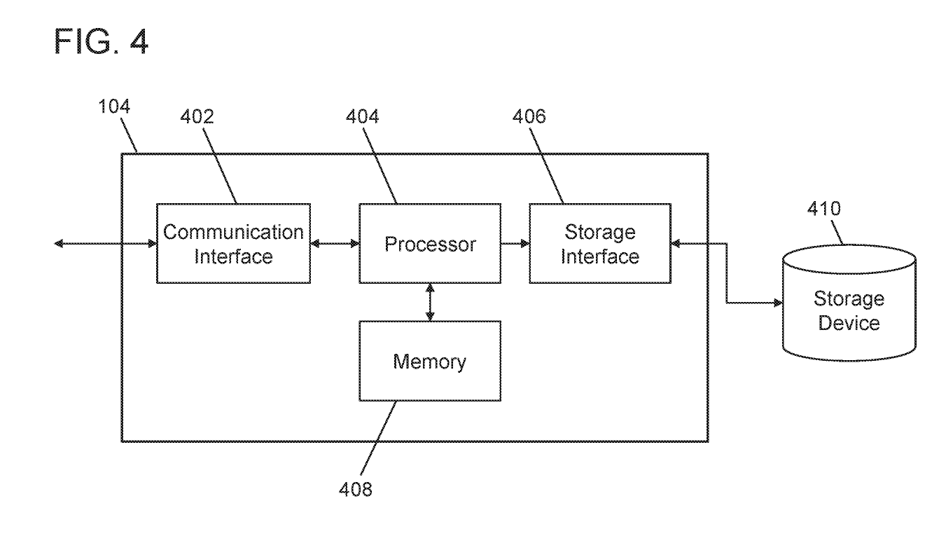

FIG. 4 illustrates an example configuration of server 104 as shown in FIG. 1. In the example embodiment, server 104 is associated with a merchant store or a bank, and stores user account data, and sends, receives, and processes signals from various sources. Server 104 may also be dynamic password computing device 110. Server 104 includes a processor 404 for executing instructions. Instructions may be stored in a memory area 408, for example. Processor 404 may include one or more processing units (e.g., in a multi-core configuration) for executing instructions. The instructions may be executed within a variety of different operating systems on server 104, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.). Processor 404 is operatively coupled to a communication interface 402 such that server 104 is capable of communicating with a remote device such as user device 106, dynamic password computing device 110, or another server 104.

Processor 404 may also be operatively coupled to a storage device 410. Storage device 410 is any computer-operated hardware suitable for storing and/or retrieving data. In some embodiments, storage device 410 is integrated in server 104. For example, server 104 may include one or more hard disk drives as storage device 410. In other embodiments, storage device 410 is external to server 104 and may be accessed by a plurality of servers 104. For example, storage device 410 may include multiple storage units such as hard disks or solid state disks in a redundant array of inexpensive disks (RAID) configuration. Storage device 410 may include a storage area network (SAN) and/or a network attached storage (NAS) system.

In some embodiments, processor 404 is operatively coupled to storage device 410 via a storage interface 406. Storage interface 406 is any component capable of providing processor 404 with access to storage device 410. Storage interface 406 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 404 with access to storage device 410.

Memory area 408 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

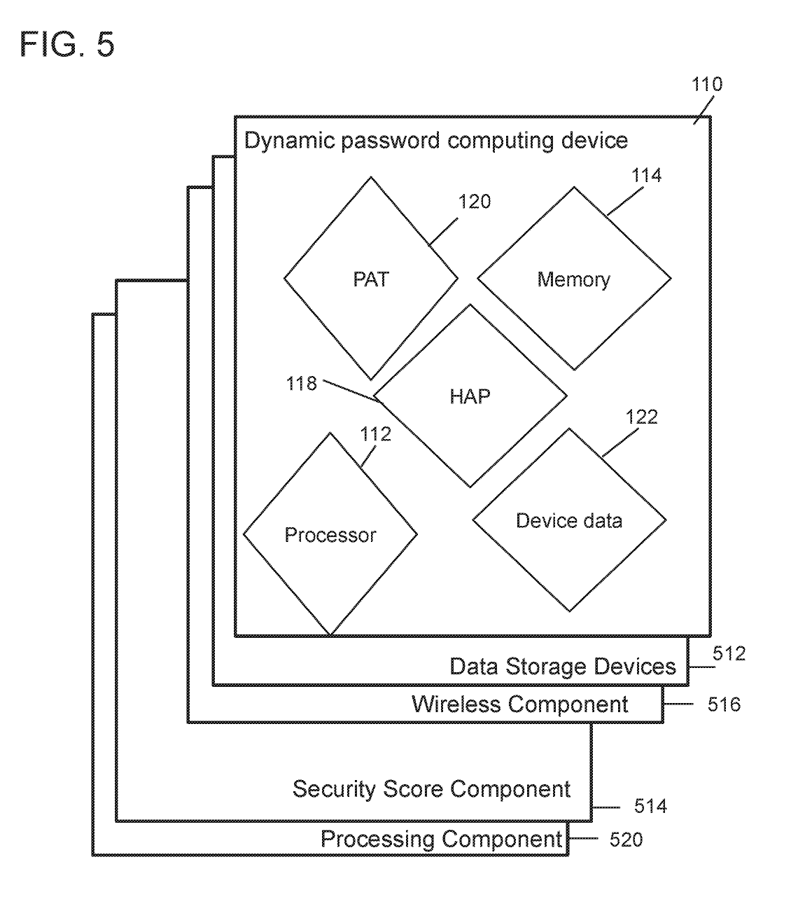

FIG. 5 is a diagram of components of one or more example dynamic password computing devices 110 that may be used in system 100 shown in FIG. 1. Dynamic password computing device 110 represents at least one dynamic password computing device 110, which itself may include or be coupled to several separate components within the computing device which perform specific tasks described herein.

In the example embodiment, dynamic password computing device 110 includes processor 112, memory 114, threshold 120, and device elements 122. As described in detail above, memory 114 stores historic account profile 118, threshold 120, and device elements 122, including, but not limited to, an IP address identifying a specific computer, a device ID identifying a specific login device, a login success rate, account data, login dates and times, and trends and login patterns for a specific user 126. As described above, memory 114 is further configured to store the plurality of rules 128 used in calculating the security score. Processor 112 is a component or components within dynamic password computing device 110 configured to process, evaluate, and analyze current device data and historic device data to generate a security score, wherein the security score is used to indicate a level of security risk associated with a login attempt. Processor 112 is further configured to communicate with at least one of memory 114, user device 106, and server 104.

Dynamic password computing device further includes data storage devices 512, which may be any suitable device used for storing a plurality of digitized data. Dynamic password computing device 110 further includes a wireless component 516 for communicating wirelessly with at least one of server 104 and/or user device 126. Dynamic password computing device further includes a security score component 514 that includes any device or component suitable for the calculation of the security score described above. Dynamic computing device 110 further includes a processing component 520 used to receive and communicate a plurality of digital data in connection with wireless component 516.

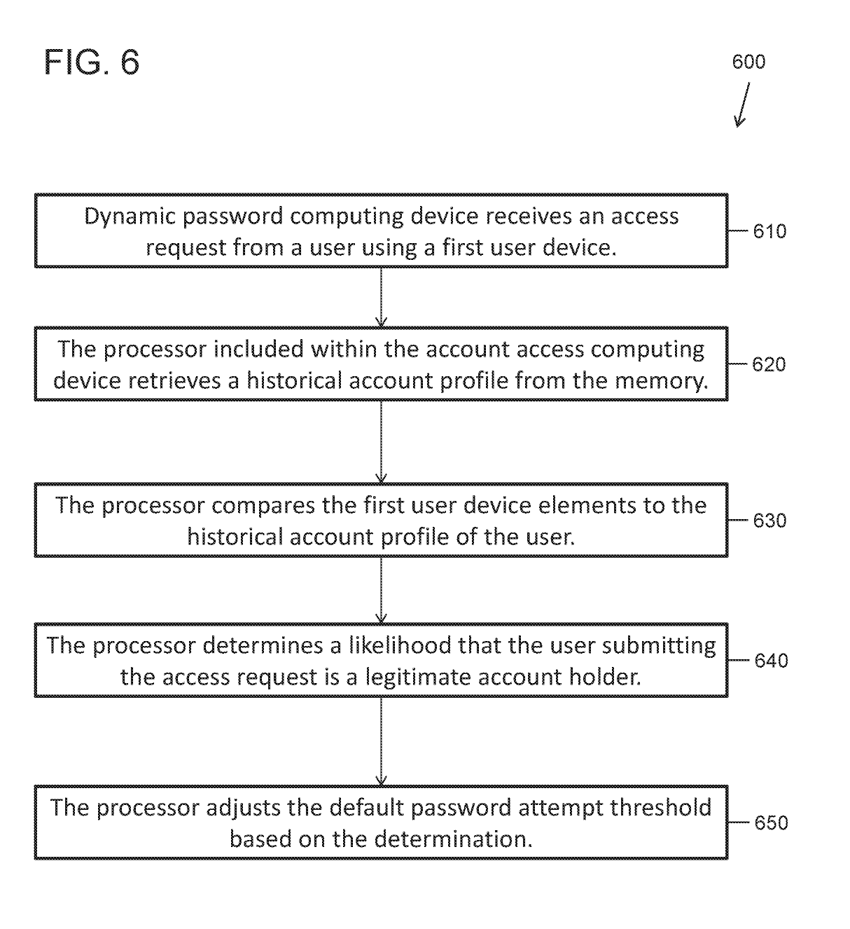

FIG. 6 shows a method 600 for dynamically adjusting the number of password attempts allowed for a digital account using system 100 shown in FIG. 1. Account access computing device first receives 610 an access request from a user using a first user device, including a plurality of first user device elements and an account ID. The processor included within the account access computing device then retrieves 620 from the memory, a historical account profile of the user based on said account ID. As described above, the historical account profile includes user device elements for one or more of the user devices used by the user to submit an access request. The processor then compares 630 the first user device elements to the historical account profile of the user, determines 640 a likelihood that the user submitting the access request is a legitimate account holder, and adjusts 650 the default password attempt threshold based on the determination.

As will be appreciated based on the foregoing specification, the above-described embodiments of the disclosure may be implemented using computer programming or engineering techniques including computer software, firmware, hardware or any combination or subset thereof, wherein the technical effect is providing positioning determination using wireless and payment transactions data. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for dynamically adjusting a default password attempt threshold used for accessing a digital account, the system comprising:
a server for storing data for multiple digital accounts including the digital account;
a dynamic password computing device for controlling access to the server and the digital account stored thereon, the dynamic password computing device comprising at least one processor and a memory, the at least one processor configured to:
store the default password attempt threshold in the memory;
receive an access request from a user using a first user device for accessing the digital account, the access request including a plurality of first user device data elements and an account ID;
retrieve, from the memory, a historical account profile of the user based on the account ID, wherein the historical account profile includes user device data elements for one or more user devices used by the user to access the digital account;
compare the first user device elements from the access request to the historical account profile of the user;
determine a likelihood that the user submitting the access request is a legitimate account holder based on the comparison; and
adjust the default password attempt threshold stored within the memory based on the determination.

2. The system according to claim 1, wherein the plurality of first user device data elements comprise metadata associated with the first user device including at least one of an IP address, a MAC address, a web browser being used by the first user device, a user device location, a date associated with the access request, and a time stored on the first user device at the time of submitting the access request.

3. The system according to claim 1, wherein the default password attempt threshold is a number of incorrect password attempts allowed to be inputted by a user before the digital account is locked or otherwise secured by the dynamic password computing device.

4. The system according to claim 1, wherein the at least one processor is further configured to generate a historical account profile for the user, wherein the historical account profile includes user device data for each of a plurality of previous logins to the digital account by the user, and associated login patterns determined by the processor.

5. The system according to claim 4, wherein associated login patterns comprise at least one of:
a common login time frame, wherein the common login time frame is a period of time defined by the most common times of login attempts from the first user device;
a common location, wherein the common location is defined by at least one common location of login attempts by the first user device;
an average time elapsed between each successive logins by the first user device;
a login success rate, wherein the login success rate is rate of successful login attempts compared to the overall number of login attempts; and
a time period defined by an amount of time between the present login attempt by the first user device and a most recent previous password reset by the first user device.

6. The system according to claim 5, wherein the at least one processor if further configured to determine the likelihood that the user submitting the access request is the legitimate account holder by performing the following:
comparing the first user device data elements with the historical data profile of the user;
comparing the first user device data elements with the login patterns associated with the user;
applying the comparison of the first user device data elements with the login patterns to a set of predetermined rules stored within the memory; and
calculating a security score.

7. The system according to claim 6, wherein the security score is an indication of a security risk that is calculated by comparing first user device data elements of a current login attempt to the historical account profile, and applying the comparison to the predetermined rules stored within the memory.

8. The system according to claim 1, wherein the at least one processor is further configured to increase or decrease the default password attempt threshold based upon a determined security score, wherein the security score is an indication of a security risk associated with a login attempt and is calculated by comparing first user device data elements of a current login attempt to the historical account profile, and applying the comparison to predetermined rules stored within the memory.

9. A dynamic password computing device for controlling access to a digital account stored on a server, the dynamic password computing device comprising at least one processor and a memory, the at least one processor configured to:
store a default password attempt threshold in the memory;
receive an access request from a user using a first user device for accessing the digital account, the access request including a plurality of first user device data elements and an account ID;
retrieve, from the memory, a historical account profile of the user based on the account ID, wherein the historical account profile includes user device data elements for one or more of the user devices used by the user to access the digital account;
compare the first user device elements to the historical account profile of the user;
determine a likelihood that the user submitting the access request is a legitimate account holder based on the comparison; and
adjust the default password attempt threshold based on the determination.

10. The computing device according to claim 9, wherein the plurality of first user device elements comprise metadata associated with the first user device including at least one of an IP address, a MAC address, a web browser being used by the first user device, a user device location, a date, and a time of the first user device at the time of submitting the access request.

11. The computing device according to claim 9, wherein the default password attempt threshold is a number of incorrect password attempts allowed to be inputted by the user before the digital account is locked or otherwise secured.

12. The computing device according to claim 9, wherein the at least one processor is further configured to generate a historical account profile for the user, wherein the historical account profile includes user device data for each of a plurality of previous logins to the digital account by the user, and associated login patterns determined by the processor.

13. The computing device according to claim 12, wherein the login patterns comprise:
a common login time frame, wherein the common login time frame is a period of time defined by the most common times of login attempts from the first user device;
a common location, wherein the common location is defined by at least one common location of login attempts by the first user device;
an average time between each successive logins by the first user device;
a login success rate, wherein the login success rate is rate of successful login attempts compared to the overall number of login attempts; and
a time period defined by an amount of time between the present login attempt by the first user device and a most recent previous password reset by the first user device.

14. The computing device according to claim 13, wherein the at least one processor is further configured to determine the likelihood that the user submitting the access request is the legitimate account holder by performing the following:
comparing the first user device data elements with the historical data profile of the user;
comparing the first user device data elements with the login patterns associated with the user;
applying the comparison of the first user device data elements with the login patterns to a set of predetermined rules stored within the memory; and
calculating a security score.

15. The computing device according to claim 14, wherein the security score is an indication of a security risk that is calculated by comparing first user device data elements of a current login attempt and the historical account profile, and applying the comparison to the predetermined rules stored within the memory.

16. The computing device according to claim 9, wherein the at least one processor is further configured to increase or decrease the default password attempt threshold based upon a determined security score, wherein the security score is an indication of a security risk associated with a login attempt and is calculated by comparing first user device data elements of a current login attempt to the historical account profile, and applying the comparison to predetermined rules stored within the memory.

17. A computer-implemented method for dynamically adjusting a default password attempt threshold used for accessing a digital account, the method is implemented using a dynamic password computing device, the method comprising:
storing, by the dynamic password computing device, a default password attempt threshold in a memory;
receiving, by the dynamic password computing device, an access request from a user using a first user device for accessing the digital account, the access request including a plurality of first user device data elements and an account ID;
retrieving, from the memory, a historical account profile of the user based on the account ID, wherein the historical account profile includes user device elements for one or more user devices used by the user to access the digital account;
comparing the first user device elements from the access request to the historical account profile of the user;
determining a likelihood that the user submitting the access request is a legitimate account holder based on the comparison; and
adjusting the default password attempt threshold based on the determination.

18. The method according to claim 17, wherein retrieving a historical account profile further comprises generating the historical account profile for the user that includes user device data from previous login attempts to the digital account by the user, and associated login patterns.

19. The method according to claim 18, wherein the login patterns comprise:
a common login time frame, wherein the common login time frame is a period of time defined by the most common times of login attempts from the first user device;
a common location, wherein the common location is defined by at least one common location of login attempts from the first user device;
an average time elapsed between each successive logins by the first user device;
a login success rate, wherein the login success rate is a rate of successful login attempts compared to the overall number of login attempts; and
a time period defined by an amount of time between the present login attempt by the first user device and a most recent previous password reset by the first user device.

20. The method according to claim 17, wherein adjusting the default password attempt threshold further comprises increasing or decreasing the default password attempt threshold based upon a determined security score, wherein the security score is an indication of a security risk associated with a login attempt and is calculated by comparing first user device data elements of a current login attempt to the historical account profile, and applying the comparison to predetermined rules stored within the memory.
